(19) United States
(12) Patent Application Publication
(10) Pub. No.: US 2022/0306926 A1
(43) Pub. Date: Sep. 29, 2022

(54) Gas Migration Mitigation for Oil and Gas Well Cements

(71) Applicant: Saudi Arabian Oil Company, Dhahran (SA)

(72) Inventors: Peter Boul, Houston, TX (US); Sivaprakash Shanmugam, Houston, TX (US); Kenneth Dejuan Johnson, Houston, TX (US)

(73) Assignee: Saudi Arabian Oil Company, Dhahran (SA)

(21) Appl. No.: 17/216,231

(22) Filed: Mar. 29, 2021

(51) Int. Cl. C09K 8/493; C04B 22/06

(52) U.S. Cl. CPC C09K 8/493; C04B 22/06; E21B 47/005

(57) ABSTRACT

A method of using a nanosilica-containing cement in a well cementing operation in a well, the method comprising the steps of pumping a nanosilica-containing cement formulation into the well, wherein the nanosilica-containing cement formulation comprises maltodextrin-coated nanosilica and a cement formulation, where the maltodextrin-coated nanosilica comprises nanosilica particles encapsulated by maltodextrin coating, wherein the pH of the nanosilica-containing cement formulation is between 9 and 14, maintaining a temperature in the well due to a temperature of a formation surrounding the well, wherein the disintegration of the maltodextrin coating is initiated due to the temperature and pH of the nanosilica-containing cement, exposing the nanosilica particles due to the disintegration of the maltodextrin coating from the maltodextrin-coated nanosilica, and reacting the nanosilica particles with the cement formulation such that the transition time is reduced.

### TECHNICAL FIELD

Disclosed are compositions and methods for use with cement. Specifically, disclosed are compositions and methods for improving the properties of cement.

### BACKGROUND

Gas migration is believed to account for 25% of cementing zonal isolation failures. Poor engineering of oil and gas well cement slurries can result in the loss of zonal isolation in a well potentially leading to the loss of a well and considerable hazard to field personnel. The appropriate selection of the additives in cement slurries depends on the temperature and pressure profiles down the length of the well, the depth of the well, the geological formations that the slurry contacts, as well as the presence of gas, water, and oil in the different zones of the well. The understanding of cement chemistry and cement additive chemistry is critically important for the appropriate design of oil well cements used in wells with these well-specific parameters.

Even with slurries which are well-engineered with commercially available cementing additives, gas migration problems have been found to occur which threaten zonal isolation. In the Kingdom of Saudi Arabia many of the gas migration problems occur in deep gas wells which have recurring difficulties with casing-casing annulus (CCA) and sustained casing pressure (SCP). SCP occurs when fluid invasion into the annulus causes building of pressure in the annulus which cannot be mitigated through bleed-down operations and leads to the casing pressure consistently rising after bleed-down.

Well-engineered cement slurries are density adjusted or weighted for the hydrostatic pressure that the cement slurry exerts on the surrounding rock formation after placement within a well. As the cement begins to hydrate and build gel strength, this hydrostatic head is diminished, making the cement particularly vulnerable to gas migration from the formation when it has little to no mechanical strength. Following API recommended practice, well-engineered cement slurries are formulated to have pumpability and a good rheological profile, good fluid loss control, no settling behavior, rapid setting after placement within the intended location in the well and appropriate weighting. In standard cementing practice, weighting agents (typically hematite or hausmannite) are added to the cement slurry such that the placed cement slurry transmits sufficient hydrostatic pressure to the formation without exceeding the fracture pressure of the formation. The hydrostatic pressure from the cement is formulated to be greater than the pore pressure from within the formation. This overbalance from the cement's hydrostatic pressure provides a means to prevent migration of fluids into the cement. In order to protect cements against loss of fluid into the formation, cements are generally formulated with fluid loss control additives. As the cement begins to hydrate it builds gel structure which results in reduction of the hydrostatic pressure transmitted by the cement slurry onto the formation. As the hydrostatic pressure drops below the pore pressure from the formation, the cement becomes susceptible to influxes of fluid (gas or liquid) from the formation. These influxes can result in channeling within the cement risking communication between zones. More specifically, the fluid influxes are known to cause a modification of the cement set time, and poor mechanical properties where the fluid influx penetrates the cement during its early hydration period.

The susceptibility of a cement slurry to gas migration can be assessed through measurement of the cement slurry transition time. The transition time is a measured time of the dynamic gel-strength development of a cement slurry under simulated well conditions of pressure and temperature. This is the period of time between when a cement has a static gel strength (SGS) between 100 lbf/100 sq ft (48 Pa) to 500 lbf/100 sq ft (240 Pa). Additives can be designed for gas migration mitigation through this test, where the gel strength development is directly evaluated.

For convenience, gas migration cementing additives can be categorized into five different generations. Natural and synthetic rubber latexes are part of the first-generation gas migration additives that are able to form barrier films within the cement matrix. Latexes are a preferred choice of gas migration additive as they are able to form a thermally stable structure and to afford film properties. Latexes, typically of 200-500 nm diameter, may have compositions inclusive of vinyl acetate, vinyl chloride, acrylics, acrylonitrile, styrene, butadiene and/or ethylene. The inclusion of latexes into cement slurry designs is known to reduce the Young's modulus of the set cement and increases the cement's mechanical “flexibility.” Latex is also known to prevent gas migration, blocking the cement matrix from fluid influx by pore plugging of the formation and the formation of films on bonding surfaces between the cement and formation. This mechanism can be considered as the physical reverse of the mechanism by which latexes are believed to contribute to fluid loss control. Whereas the pore plugging in a weighted cement slurry prevents the loss of fluid into the formation in fluid loss control, the latexes are also believed to block fluid flowing in the opposite direction from the formation after the cement slurry loses enough hydrostatic head to become susceptible to gas migration. However, a minimum of 5% by weight of cement of the latex is needed. The high cost associated to natural and synthetic latexes led to the development of the second-generation gas migration additives based on inorganic materials.

Second generation materials such as ironite sponge help to eliminate the microannulus with the pipe, anchorage clay minimizes the cement body pores, and carbon black is believed to be able to slow the migration of gas through the cement column. However, some of the second-generation materials can compromise compressive strength and require surfactant stabilizers.

A third-generation of polymer-based materials was then introduced. These materials are easily synthesized in a cost-effective manner and have become an important source of gas migration additives. Such polymer-based materials include polymer latex particles stabilized by surfactant, suspensions of polymeric microgels, liquid polymer, microgel, water activated low MW polymer for cold environments, combination of latex particles and liquid polymer, and solid polymers. These additives address gas migration through the pore blocking and film formation mechanisms, however do not shorten the transition time for the cement slurry to minimize the risk of gas migration due to the loss of hydrostatic pressure.

Cement slurries can also be designed to mitigate gas migration through a different mechanism—shortening of the transition time. FIG. 1 illustrates the transition time in the context of well operations. Organic and inorganic nanoparticles were explored as fourth generation gas migration additives due to their high surface areas and additional enhancements provided such as improved compressive strength and reduced cement porosity. Of the fourth-generation gas migration additives explored so far, silica nanoparticles show the most promising results. Unlike polymer-based materials that generate films to seal channels, silica nanoparticles help to create additional nucleation sites for the generation of C-S-H to quickly build gel strengths that prevent formation gases from migrating into the cement. Nanosilicas added to oil and gas well cement have been shown to accelerate cement hydration, reduce the porosity of the set cement by up to 50% and reduce the permeability of the cement by roughly 10%. These qualities have been previously proposed as indicative of the potential for gas migration mitigation, however, there are known rheological effects associated with adding nanosilicas to cements. It is known that cements loaded with nanosilicas produce gels prematurely which has the deleterious effect of leading to air entrainment in cement and poor pumpability of cement slurries designed with these additives. This property can also interfere with gas migration mitigation because it is the formation of the gel that reduces the hydrostatic pressure on the formation which can allow for fluid from the formation to invade the cement prior to building enough mechanical strength to resist such an influx.

### SUMMARY

Disclosed are compositions and methods for use with cement. Specifically, disclosed are compositions and methods for monitoring cement in a downhole environment.

In a first aspect, a method of using a nanosilica-containing cement in a well cementing operation in a well is provided. The method includes the steps of pumping a nanosilica-containing cement formulation into the well, wherein the nanosilica-containing cement formulation includes maltodextrin-coated nanosilica and a cement formulation, where the maltodextrin-coated nanosilica includes nanosilica particles encapsulated by maltodextrin coating, wherein the pH of the nanosilica-containing cement formulation is between 9 and 14, maintaining a temperature in the well due to a temperature of a formation surrounding the well, wherein the disintegration of the maltodextrin coating is initiated due to the temperature and pH of the nanosilica-containing cement, exposing the nanosilica particles due to the disintegration of the maltodextrin coating from the maltodextrin-coated nanosilica, and reacting the nanosilica particles with the cement formulation to form a set cement, wherein the transition time of the nanosilica-containing cement formulation is reduced compared to the transition time of the cement formulation.

In certain aspects the method further includes the steps of mixing an amount of maltodextrin with a nanosilica particle solution to produce a maltodextrin-containing solution, where the nanosilica particle solution includes the nanosilica particles suspended in water, where mixing continues until all of the maltodextrin is dissolved, mixing an amount of borate with the maltodextrin-containing solution to produce a pre-reaction mixture, where the borate is selected from the group consisting of sodium tetraborate, potassium tetraborate, boric acid, and combination of the same, sonicating the pre-reaction mixture in an ultrasonic bath to produce a sonicated mixture at a temperature between 90° F. (32.2° C.) and 100° F. (37.8° C.), mixing the sonicated mixture at ambient conditions for at least 12 hours to produce the reaction mixture, and separating the reaction mixture to produce the maltodextrin-coated nanosilica, wherein the maltodextrin is covalently bound to a surface of the nanosilica particles through a boronic ester functional group. In certain aspects, the method further includes the step of mixing the maltodextrin-coated nanosilica and the cement formulation to produce the nanosilica-containing cement formulation. In certain aspects, the nanosilica particles in the nanosilica-containing cement formulation are present in an amount between 0.01% by weight of cement and 10% by weight of cement.

In a second aspect, a composition to provide on-demand release of a silica nanoparticle into a cement formulation is provided. The composition includes a maltodextrin-coated nanosilica particle, which includes a nanosilica particle and a maltodextrin coating, where the maltodextrin coating includes a boronic ester bound maltodextrin surrounding the nanosilica particle. The composition further includes the cement formulation, which includes water and a cement.

A method of producing a nanosilica-containing cement formulation is provided. The method includes the steps of mixing an amount of maltodextrin with a nanosilica particle solution to produce a maltodextrin-containing solution, where the nanosilica particle solution includes nanosilica particles suspended in water, where mixing continues until all of the maltodextrin is dissolved, mixing an amount of borate with the maltodextrin-containing solution to produce a pre-reaction mixture, where the borate is selected from the group consisting of sodium tetraborate, potassium tetraborate, boric acid, and combination of the same, sonicating the pre-reaction mixture in an ultrasonic bath to produce a sonicated mixture at a temperature between 90° F. (32.2° C.) and 100° F. (37.8° C.), mixing the sonicated mixture at ambient conditions for at least 12 hours to produce the reaction mixture, separating the reaction mixture to produce a maltodextrin-coated nanosilica, and mixing the maltodextrin-coated nanosilica with cement formulations to produce the nanosilica-containing cement formulations, where the cement formulations include water and a cement.

### BRIEF DESCRIPTION OF THE DRAWINGS

These and other features, aspects, and advantages of the scope will become better understood with regard to the following descriptions, claims, and accompanying drawings. It is to be noted, however, that the drawings illustrate only several embodiments and are therefore not to be considered limiting of the scope as it can admit to other equally effective embodiments.

FIG. 1 is a schematic showing cement placement and gas migration in oil and gas wells.

FIG. 2 is a schematic representation of the reaction between maltodextrin, sodium tetraborate, and a nanosilica particle to produce a maltodextrin-coated nanosilica.

FIG. 3 is a schematic representation of an maltodextrin-coated nanosilica after a change in temperature results in the disintegration of the maltodextrin-coated nanosilica into a maltodextrin coating fragment and the nanosilica particle.

FIG. 4 is a raw XRD diffraction pattern and match of Saudi G cement.

FIG. 5 is a graph of thermogravimetric analysis from Example 2.

FIG. 6A is a DLS analysis (intensity distribution) of uncoated nanosilica particles.

FIG. 6B is a DLS analysis of a maltodextrin-coated nanosilica.

FIG. 6C is a DLS analysis of a maltodextrin-coated nanosilica.

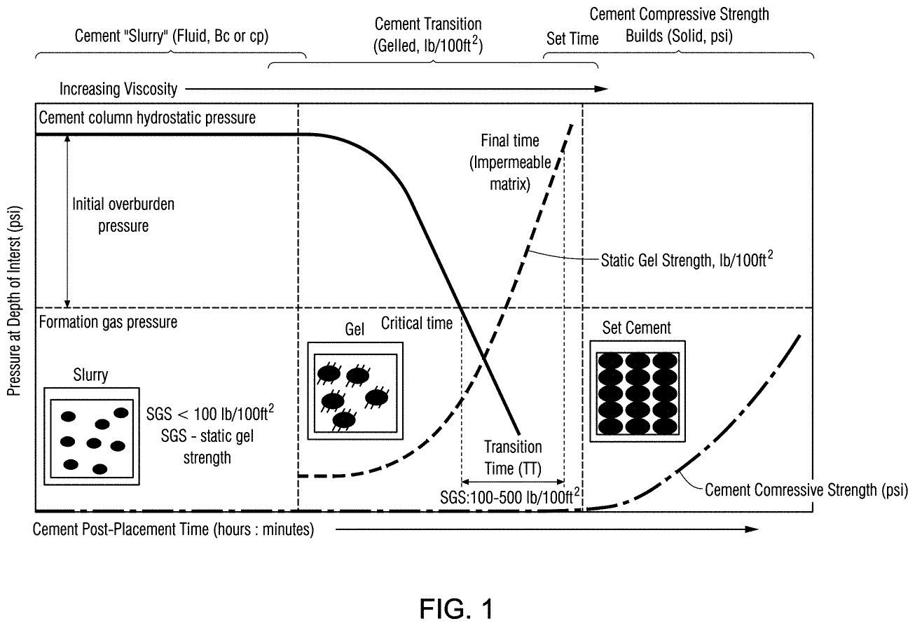

In the accompanying Figures, similar components or features, or both, may have a similar reference label.

### DETAILED DESCRIPTION

While the scope of the apparatus and method will be described with several embodiments, it is understood that one of ordinary skill in the relevant art will appreciate that many examples, variations and alterations to the apparatus and methods described here are within the scope of the embodiments.

Accordingly, the embodiments described are set forth without any loss of generality, and without imposing limitations, on the embodiments. Those of skill in the art understand that the scope includes all possible combinations and uses of particular features described in the specification.

The maltodextrin-coated nanosilica compositions described here advantageously overcome the problems associated with prior generations of nanosilicas. The maltodextrin coating on the nanosilica particle is a stimuli-responsive coating that can degrade under certain temperature or pH conditions. Advantageously, the maltodextrin-coated nanosilica when added to a cement slurry can shorten the transition time of the cement slurry after placement within the well. Advantageously, the maltodextrin-coated nanosilica can be used in cement compositions, where the released nanosilica particles can improve the cement properties. Advantageously, the maltodextrin-coated nanosilica can be better dispersed in the cement formulations compared to silica nanoparticles without encapsulation. Advantageously, the maltodextrin-coated nanosilica provides a method to modulate the reactivity of nanosilica particles in cement formulations. Advantageously, the nanosilica-containing cement formulations can improve cement properties and processes, including acceleration of the cementing process, early gel strength development, reduction of cement porosity, greater control over cement formulation rheology and improvements on colloidal silica nanoparticle dispersions can be achieved.

In order to mitigate the issues of cement slurry gelation, the methods to encapsulate the nanosilica particles render the nanoparticles inert to the surrounding cement slurry. The compositions and methods described can delay release of the nanosilica particles to the cement slurry such that the gelation phenomena are not observed when the cement slurry is being placed in the well. The release of the nanosilica particles allows for the exposure of the nanosilica particles to the cement when already placed such that the rheological side effects of the nanosilica particles do not inhibit the pumpability of the cement slurry. The nanosilica particles can be released from the maltodextrin coating due to the temperature and pH after the cement slurry is placed in the well. After decomposition of the maltodextrin coating, the isolated nanosilica particle is activated to provide rapid acceleration of the tricalcium silicate (C₃S) hydration to calcium silicate hydrate (C-S-H). Rapid acceleration corresponds to gel strength development between 100 and 500 lbf/100 sq ft.

As used throughout, “nanosilica loading” refers to the amount of nanosilica solids per unit volume of fluid.

As used throughout, “disintegrate” or “disintegration” means breaking into smaller parts or pieces, such as fragmentation. In the context of disintegration of molecules, the parent molecule breaks into smaller, lower molecular weight species.

As used throughout, “well-mixed” means a fluid composition that is thoroughly blended such that the fluid composition approaches a homogeneous mixture where all components are equally distributed throughout the fluid composition.

Compositions are directed to an maltodextrin-coated nanosilica. The maltodextrin-coated nanosilica includes a nanosilica particle and a maltodextrin coating. The maltodextrin coating surrounds the nanosilica particle preventing reaction between the nanosilica particle and the cement formulation. Each individual nanosilica particle can be encapsulated with a maltodextrin coating. Alternately, an aggregate of nanosilica particles can be encapsulated with a maltodextrin coating.

The nanosilica particles can be any type of nanoparticle silica. In at least one embodiment, the nanosilica particles can include colloidal silica nanoparticles.

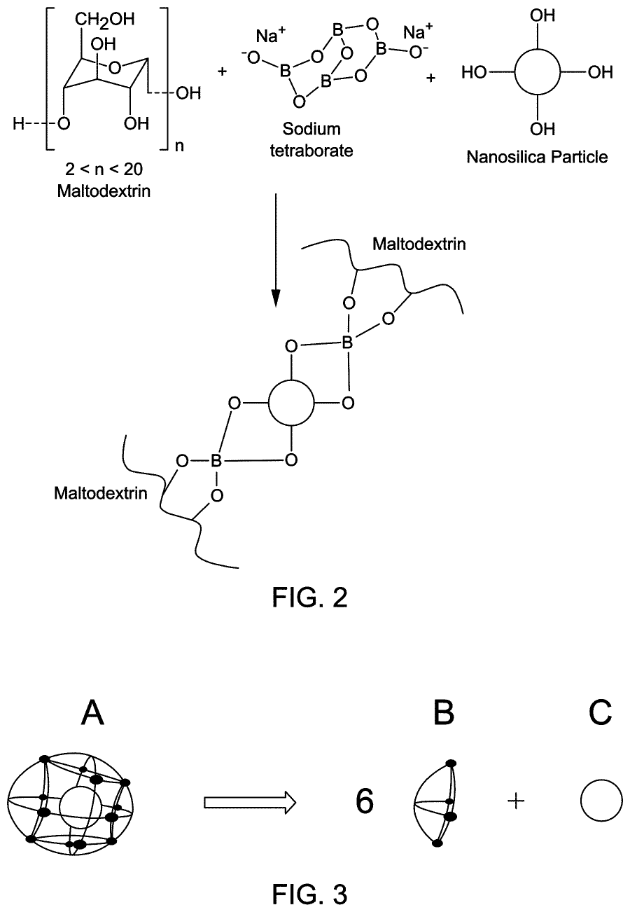

The maltodextrin coating is a boronic ester bound maltodextrin polymer surrounding the nanosilica particles. Maltodextrin is a short chain of 3 to 17 repeating glucose units (oligosaccharides) principally linked through glycosidic bonds that can dissolve in water. The maltodextrin coating is hydrophilic. Advantageously, the hydrophilic nature of the maltodextrin coating enables the dispersion of the maltodextrin-coated nanosilica. The reaction between maltodextrin, sodium tetraborate and the nanosilica particles is shown in FIG. 2. The Si—OH functionalities on the surface of the nanosilica particles are condensed with borate to render the maltodextrin-coated nanosilica. The sacrificial nature of the maltodextrin coating means the maltodextrin coating can disintegrate, as illustrated in FIG. 3. The maltodextrin-coated nanosilica (A) disintegrates upon application of heat to produce a maltodextrin coating fragment (B) and nanosilica particle (C).

In at least one embodiment, the disintegration can be due to an increase in the temperature of the maltodextrin-coated nano silica. The target temperature to trigger disintegration of the maltodextrin coating is between 180° F. (82° C.) and 932° F. (500° C.) and alternately, between 180° F. (82° C.) and 228° F. (108.9° C.). At temperatures of 120° F. (48.9° C.) and below, the temperature is not adequate to cause the maltoxdextrin coating to disintegrate and the nanosilica particle is not released and cannot react with the cement. At temperatures of 250° F. (121.1° C.) and above, the presence of nanosilica particles on the cement is minimal compared to the impact due of other components in the cement.

In at least one embodiment, the maltodextrin coating disintegrates due to the pH of the cement formulation. At pH between 9 and 14 and alternately between 10 and 14, the glycosidic bonds of the maltodextrin can cleave causing disintegration.

The maltodextrin-coated nanosilica can be prepared according to the following methods and embodiments. An amount of maltodextrin can be mixed with a nanosilica particle solution. The nanosilica particle solution contains nanosilica particles suspended in water. The nanosilica particle solution can be prepared by adding nanosilica particles dropwise to water or can be obtained commercially. The nanosilica particles can be suspended in water with a concentration of nanosilica particles in an amount between 0.05% by weight of water (bwow) and 40% bwow. The concentration of nanosilica particles in the nanosilica-containing water can depend on the volume of maltodextrin-coated nanosilica to be produced. The nanoparticle solution can be stirred to ensure a well-mixed nanosilica particle solution.

The maltodextrin can be mixed with the nanosilica particle solution at ambient conditions. Mixing can be achieved by any means that results in dissolving the maltodextrin to produce a maltodextrin-containing water that is well-mixed. In at least one embodiment, mixing can be achieved by stirring the maltodextrin into the nanosilica particle solution. The amount of maltodextrin that can be used is between 0.1 and 45 wt % in a nanosilica particle solution containing between 0.05% bwow and 40% bwow. The amount of maltodextrin and the rate of addition can be selected based on obtaining a maltodextrin-containing water where all of the maltodextrin is dissolved. The maltodextrin can be added in a solid form, such as a powder.

After the maltodextrin completely dissolves the borate can be added to the maltodextrin-containing water to produce a pre-reaction mixture. Examples of borates suitable for use include sodium tetraborate, potassium tetraborate, boric acid, and combination of the same. The volume of borate and the rate of addition can be selected based on the volume of maltodextrin-coated nanosilica to be produced. The pre-reaction mixture can be stirred for a period of time after addition of the borate. The maltodextrin is added before the borate to facilitate hydrogen boding between the maltodextrin and the nanosilica particles before the introduction of the borate crosslinker. If the borate was added before the maltodextrin than the borate would crosslink the nanosilica particles and the maltodextrin coating would not be formed. By introducing the maltodextrin before the borate, a thin layer of maltodextrin hydrogen bonded on the surface of the nanosilica particles, this thin layer is then crosslinked by the sodium tetraborate.

The pre-reaction mixture is then sonicated in an ultrasonic bath at a temperature of between 90° F. (32.2° C.) and 100° F. (37.8° C.) for at least one hour to produce the reaction mixture. Increasing the temperature increases the solubility of borate allowing the borate ester formation between the maltodextrin layer and nanosilica particles. Sonicating the pre-reaction mixture helps to disperse the nanosilica particles and reduces the probability of interparticle crosslinking. Additionally, the dilute conditions of the reaction can help to avoid interparticle crosslinking. Interparticle crosslinking needs to be avoided because it reduces the surface area of the nanosilica particles. Reduced surface area of the nanosilica particles translates into less effective additive in reducing the transition time of the cement.

Mixing of the reaction mixture continues after the ultrasonic bath at ambient temperature for a mixing time. The temperature can be reduced after the borate dissolves. The reaction continues during the mixing step and the mixing time is selected to ensure complete consumption of the borate and to maximize formation of the ester bonds between maltodextrin and nanosilica particles. In at least one embodiment, the mixing time is at least 12 hours.

The reaction mixture can then be separated to produce the maltodextrin-coated nanosilica. Any separation unit capable of separating a particle from a liquid can be used. Separation units can include filters, evaporation units, centrifuge units, and combinations of the same.

Maltodextrin-coated nanosilica can be used in well cementing operations and in construction industry cementing operations as gas migration additives. Well cementing operations includes any cementing operating occurring in a well in a subsurface formation. Wells can include oil wells, gas wells, and combinations of the same. The temperature of the nanosilica-containing cement formulation can be maintained due to the temperature of the formation surrounding the well.

In at least one embodiment, the maltodextrin-coated nanosilica can be mixed in cement formulations to produce nanosilica-containing cement formulations. The nanosilica-containing cement formulations include maltodextrin-coated nanosilica and cement formulations. The cement formulations can include water and a cement. The cement can be any Portland cement containing calcium silicates, aluminosilicates, or combinations of the same. The nanosilica-containing cement formulations can include nanosilica particles in an amount between 0.1% by weight of cement (bwoc) and 10% bwoc. Advantageously, the maltodextrin coating of the maltodextrin-coated nanosilica can reduce agglomerations of silica nanoparticles due in part to the hydrophilic nature of the maltodextrin coating. Advantageously, the maltodextrin coating of the maltodextrin-coated nanosilica can maintain the pumpability of the nanosilica-containing cement formulations at increased nanosilica loading.

The maltodextrin coating can act as a protective barrier isolating the nanosilica particles from calcium silicates in the cement and their reaction products with water. Isolating the nanosilica particles can delay reaction between the nanosilica particles and calcium silicates until desired, such that the cement properties can be optimized when the cement formulation is the desired location.

The temperature and pH of the maltodextrin-coated nanosilica can initiate the disintegration of the maltodextrin coating leaving the nanosilica particle dispersed in the cement formulation. The nanosilica particle dispersed in the cement formulation can improve the properties of the cement and set cement, including improving the mechanical properties, accelerating the cement set time, and serving as a gas migration additive. The dispersed nanosilica particle can accelerate the hydration reaction of the calcium silicate to produce calcium-silicate-hydrate, or set cement. The cement formulation with the nanosilica particles dispersed sets at an accelerated rate relative to cements without nanosilica particles. The nanosilica-containing cement formulation can have a reduced transition time compared to cements in the absence of nanosilica particles. The transition time is measured as the amount of time needed for a cement to have a static gel strength (SGS) between 100 lbf/100 sq ft (48 Pa) to 500 lbf/100 sq ft (240 Pa). The maltodextrin coating does not participate in the hydration reactions of the calcium silicate. In at least one embodiment, the nanosilica particle can undergo a pozzolanic reaction to yield a calcium silicate hydrate. In at least one embodiment, the nanosilica particle can act as a nucleation site during cement hydration. Cement properties that can be improved include reduced gas migration, improved initial gel strength of the cement, improved mechanical strength of the set cement, and accelerated cement setting.

The reactions between nanosilica particles and calcium in the cement can begin to occur within 1 minute of the disintegration of the maltodextrin coating, alternately within 5 minutes of the disintegration of the maltodextrin coating, and alternately within 1 hour of the disintegration of the maltodextrin coating. The reactions can continue until the reactants are depleted or the hardened cement reduces the ability for the reactants to interact.

The maltodextrin-coated nanosilica and the nanosilica-containing cement formulations are in the absence of dextran.

### EXAMPLES

The following experiments were performed to tests various aspects of the gas migration additive and impact on cement slurry formulations.

### Example 1. Nanosilica Synthesis and Characterization

Nanosilica particles (ST-XS, CASRN: 7732-18-5, 7631.86-9, 20 wt %) were obtained from Nissan Chemical America Corporation (Houston, Tex.). Maltodextrin (CAS: 9050-36-6) was acquired from Spectrum Chemical Manufacturing Corporation (New Brunswick, N.J.). Sodium tetraborate (CAS:1330-43-4) from Sigma Aldrich (St. Louis, Mo.) was purchased and used as received.

Samples of maltodextrin-coated nanosilica were prepared according to the following methodology. The amount of ST-XS was added drop by drop into water under stirring at 300 revolutions per minute (rpm) at ambient temperature. Stirring was allowed to continue for 15 minutes after complete addition. The amount of maltodextrin was then slowly added to the mixture as it was continuously stirred. Stirring was continued for 15 minutes until the maltodextrin completely dissolved in water to produce the maltodextrin-containing water. Then the amount of sodium tetraborate was slowly added to the mixture under stirring and stirring was continued for 15 minutes after all of the sodium tetraborate was added. The pre-reaction mixture was sonicated in an ultrasonic bath (Branson Ultrasonics Corporation (Brookfield, Conn.) 5800 Ultrasonic Cleaner, 2.5 gallon, 40 kHz) for 1 hour at a temperature between 90° F. and 100° F., followed by stirring for 12 hours at 300 rpm at ambient temperature. The reaction mixture was then filtered with an EZFlow® Syringe Filter from Foxx Life Sciences (Salem, N.H.) with a diameter of 25 mm and a pore size of 0.45 μm to recover the maltodextrin-coated nanosilica. The amounts of each component are shown in Table 3. The volume of water in each sample was 100 mL. The ST-XS 20 wt % solution contained approximately 7.8 grams of silica nanoparticles.

TABLE 3
Pre-reaction mixture composition

| Materials | Sample 1 | Sample 2 |
|---|---|---|
| Water (g) | 100 | 100 |
| ST-XS (g) | 39 | 39 |
| Maltodextrin (g) | 0.325 | 0.325 |
| Sodium tetraborate (g) | 0.050 | 0.025 |

Thermogravimetric analyses (TGA) of the maltodextrin-coated nanosilica were performed on a TA Instruments (New Castle, Del.) Thermogravimetric Analyzer (SDT Q600). Prior to running the TGA, water was removed from the samples through a drying step (under air) followed by drying in a vacuum oven at 100° F. for a week to ensure maximum removal of water. Thermogravimetric analysis was then performed with uncoated nanosilica (ST-XS) and the samples, Sample 1 and Sample 2. All samples tested were heated, at a constant rate of 20° C. per min using air as the furnace gas, from room temperature to 1000° C. to ensure complete removal of residual water in uncoated nanoparticles and removal of residual water and organic content in the maltodextrin-coated nanosilica samples. By using the uncoated nanosilica particle as a baseline, the Baseline Sample, for the presence of residual water, a percentage mass loss due to organic content removal was then determined for the maltodextrin-coated nanosilica, shown in Table 4. The theoretical weight loss was calculated as the weight of maltodextrin and sodium tetraborate divided by the weight of the nanosilica particles, maltodextrin, and sodium tetraborate as a percentage. The experimental weight loss was calculated as the difference between the weight loss of the maltodextrin-coated nanosilica and the weight loss of the uncoated nanosilica. The weight loss of the uncoated nanosilica is assumed to be from water and other organic material present with the nanosilica particles. Thus, subtracting the difference in the uncoated nanosilica from the maltodextrin-coated nanosilica determines the weight loss purely due to the maltodextrin-borate coating. The mass percentage of the maltodextrin coating was also estimated by determining the percentage ratio of experimental mass loss to theoretical mass loss.

TABLE 4
Analysis of mass loss for Sample 1 and Sample 2 of nanosilica particle

| | Theoretical | Experimental | Percentage of |
|---|---|---|---|
| | weight loss (%) | weight loss (%) | maltodextrin coating (%) |
| Sample 1 | 4.6 | 3.94 | 86 |
| Sample 2 | 4.3 | 2.67 | 62 |

Dynamic light scattering (DLS) and zeta potential measurements were performed using a Litesizer™ 500 particle analyzer running Kalliope software from Anton Paar (Houston, Tex.) with a 40 mW semiconductor laser, λ=658 nm. The temperature was stabilized to ±0.1° C. of the set temperature 25° C. All samples were prepared in Milli-Q water at a concentration of about 77 mg/ mL nanosilica particles and filtered through a 0.45 μm pore size filter to remove dust prior to measurement. Hydrodynamic radii were calculated by the non-negative least squares (NNLS) algorithm and the zeta potential was determined by the Smoluchowski approximation using the manufacturer's software. Forced single exponential fitting scheme (cumulant method) was used to determine the overall mean size by intensity distribution. The results of the DLS measurements are shown in Table 5.

TABLE 5
Results of DLS and zetal potential measurements.

| | Hydrodynamic | Polydispersity | Zeta potential |
|---|---|---|---|
| | diameter (nm) | Index | (mV) |
| Baseline Sample | 13.17 | 0.282 | −25.5 ± 1.2 |
| Sample 1 | 28.44 | 0.225 | −26.9 ± 0.6 |
| Sample 2 | 17.92 | 0.216 | −18.4 ± 0.7 |

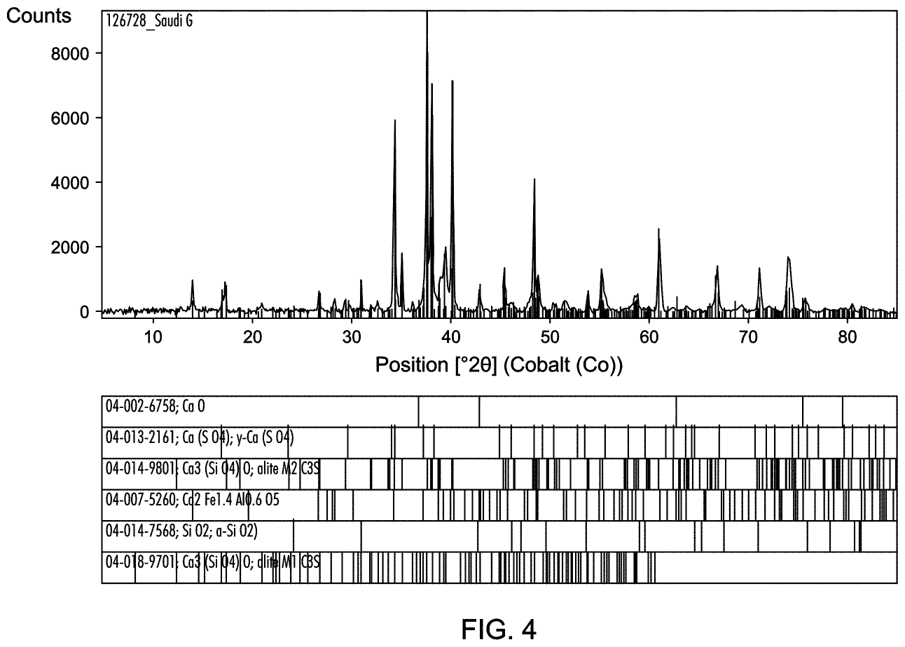

An increase in the hydrodynamic diameter in the maltodextrin-coated nanosilica samples was seen when compared to the uncoated nanosilica particles. The increase in hydrodynamic diameter indicated the presence of polymer tethered to the surface of nanosilica particles. A higher hydrodynamic diameter was seen in Sample 1 over Sample 2 due to the presence of larger tethered maltodextrin content in the former sample. In addition, the higher concentration of sodium tetraborate used in Sample 1 may help to increase chain branching which can contribute to the higher hydrodynamic diameter. Zeta potential values provide an indirect measurement of the net charge on the nanoparticle surface. The zeta potential value for Sample 1 shifted to a slightly more negative value when compared to the Baseline Sample due to the presence of sodium tetraborate on the surface of the particle. The value of the zeta potential for Sample 1 at −26.9 mV is in the standard range for stable colloidal suspensions of nanosilica particles. Sample 2 shifted to a slightly less negative value when compared to the Baseline Sample. The DLS intensity distribution plots are shown in FIGS. 4A-4C. FIG. 4A shows the DLS analysis (intensity distribution) for the Baseline Sample. FIG. 4B shows the DLS analysis (intensity distribution) for Sample 1. FIG. 4C shows the DLS analysis (intensity distribution) for Sample 2.

### Example 2. Cement Slurry Formulation and Characterization

Cement slurry formulations were developed and tested at different temperatures for high pressure/high temperature (HPHT) thickening time and multiple analysis cement system II (MACSII) transition time using HPHT ultrasonic cement analyzers (UCAs) and HPHT consistometer testing. In the formulations, the cement was a Saudi class G cement and the gas migration additive (nanosilica additive) was a Sample from Example 1, as indicated. In order to compare the efficacy of the gas migration additives, the components were tuned to achieve a set HPHT pump time. The UCAs used were Chandler 4265 HT. All tests were carried out according to API Recommended Practice 10B. The pressure in all tests with the UCA was set to 20.7 MPa. The temperature ramps were set to ramp to the target temperatures in 0.5 hour. There were four different target temperatures set in the UCA experiments 120° F., 180° F., 250° F., and 228° F. The HPHT consistometers were Chandler Model 8340.

A. Slurry Formulation Designs for 120° F.

The slurry formulations for the 120° F. tests were developed according to the compositions shown in Table 6. A retarder system of zinc oxide and AMPS/acrylic acid copolymer was used. The slurry formulations were adjusted to display thickening times to 100 Bearden units of consistency (Bc) of approximately 6 hours. For each test, a 30 minute ramp time to 120° F. was used to determine the transition time.

TABLE 6
Slurry formulation designs for 120° F.

| | Baseline | | Uncoated | | Sample 1 | |
|---|---|---|---|---|---|---|
| | Formulation | | Formulation | | Formulation | |
| | Amount (g) | % BWOC | Amount (g) | % BWOC | Amount (g) | % BWOC |
| Saudi class G cement | 785 | 100 | 785 | 100 | 785 | 100 |
| Water | 347 | N/A | 347 | N/A | 347 | N/A |
| Hydroxyethylcellulose | 1.00 | 0.13 | 1.00 | 0.13 | 1.00 | 0.13 |
| AMPS Acrylic Acid | 1.85 | 0.236 | 1.85 | 0.236 | 1.94 | 0.247 |
| copolymer | | | | | | |
| Zinc Oxide | 0.59 | 0.075 | 0.59 | 0.075 | 0.61 | 0.078 |
| Nanosilica Additive | 0 | 0 | 3.93 | 0.05 gps | 3.93 | 0.05 gps |

For the tests at 120° F., the slurry formulations were adjusted to display thickening times to 100 Bearden units of consistency (Bc) of approximately 6 hours. For each test, a 30 minute ramp time to 120° F. was used. Three hours of conditioning at 120° F. was used to determine the transition time. Thickening times and transition times for each sample are shown in Table 7.

TABLE 7
Thickening times and transition times

| | Baseline | Uncoated | Sample 1 |
|---|---|---|---|
| | Formulation | Formulation | Formulation |
| Thickening time to | 6 hours and | 5 hours and | 5 hour and |
| 70 Bc | 15 minutes | 54 minutes | 49 minutes |
| Thickening time to | 6 hours and | 6 hours and | 6 hours and |
| 100 Bc | 23 minutes | 2 minutes | 2 minutes |
| Transition times | 42 minutes | 60 minutes | 64 minutes |

The results in Table 7 suggest no advantage to the use of maltodextrin-coated nanosilica in a cement formulation in terms of thickening time or transition time. Furthermore, the maltodextrin-coated nanosilica in Sample 1 Formulation does not improve the transition time relative to the use of uncoated nanosilica in the Uncoated Formulation. At a temperature of 120° F., the results suggest that the maltodextrin remains intact, in other words the maltodextrin coating does not thermally degrade, and there may have been some free maltodextrin which acted as a mild cement retarder, hence the longer transition time with the coated nanosilica.

B. Slurry Formulation Designs for 180° F.

The slurry formulations for the 180° F. tests were developed according to the compositions shown in Table 8. The slurry formulations were adjusted to display thickening times to 100 Bearden units of consistency (Bc) of approximately 6 hours. For each test, a 30 minute ramp time to 180° F. was used. Three hours of conditioning at 180° F. was used to determine the transition time. A retarder system of zinc oxide and AMPS/acrylic acid copolymer was used. The slurry formulations were mixed at room temperature (about 21° C.) in a Fann 686CS cement stand mixer using deionized water for the mixing times outlined in API RP 10B.

TABLE 8
Slurry designs for 180° F.

| | Baseline | | Uncoated | | Sample 1 | | Sample 2 | |
|---|---|---|---|---|---|---|---|---|
| | Formulation | | Formulation | | Formulation | | Formulation | |
| | Amount (g) | % BWOC | Amount (g) | % BWOC | Amount (g) | % BWOC | Amount (g) | % BWOC |
| Saudi class G cement | 785 | 100 | 785 | 100 | 785 | 100 | 785 | 100 |
| Water | 347 | N/A | 347 | N/A | 347 | N/A | 347 | N/A |
| Hydroxyethylcellulose | 1.00 | 0.13 | 1.00 | 0.13 | 1.00 | 0.13 | 1.00 | 0.13 |
| AMPS Acrylic Acid | 1.85 | 0.236 | 1.94 | 0.247 | 1.94 | 0.247 | 1.18 | 0.150 |
| copolymer | | | | | | | | |
| Zinc Oxide | 0.59 | 0.075 | 0.61 | 0.078 | 0.61 | 0.078 | 0.38 | 0.049 |
| Nanosilica Additive | 0 | 0 | 3.93 | 0.05 gps | 3.93 | 0.05 gps | 3.94 | 0.05 gps |

For the tests at 180° F., the slurry formulations were adjusted to display thickening times to 100 Bc of approximately 4 hours. For each test, a 30 minute ramp time to 180° F. was used. Two hours of conditioning at 180° F. was used to determine the transition time. Thickening times and transition times for each sample are shown in Table 9.

TABLE 9
Thickening times and transition times

| | Baseline | Uncoated | Sample 1 | Sample 2 |
|---|---|---|---|---|
| | Formulation | Formulation | Formulation | Formulation |
| Thickening time | 4 hours | 3 hours and | 4 hours and | 4 hours and |
| to 70 Bc | | 57 minutes | 7 minutes | 2 minutes |
| Thickening time | 4 hours | 4 hours and | 4 hours and | 4 hours and |
| to 100 Bc | | 1 minute | 11 minutes | 10 minutes |
| Transition times | 39 minutes | 41 minutes | 29 minutes | 10 minutes |

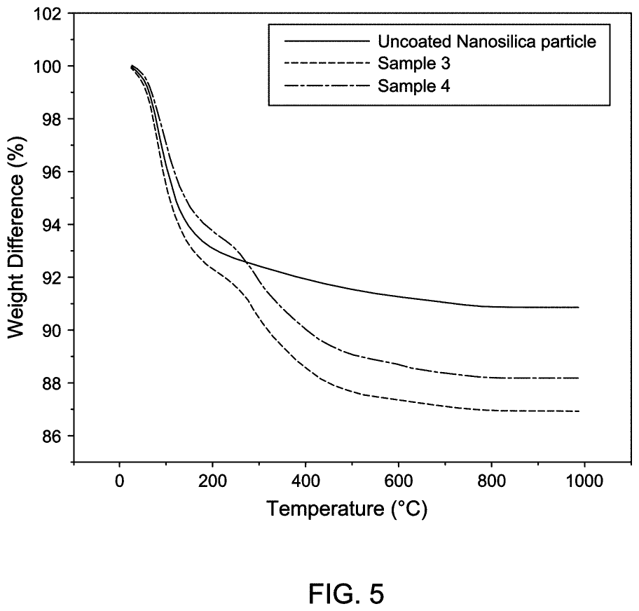

The results in Table 9 show different activity of the nanosilica particles at 180° F. than from the results in Table 7. The results show that cement slurries, the slurry formulations containing the gas migration additives, have substantially shorter transition times compared to the slurry formulations with no nanosilica or uncoated nanosilicas. Thus, the results suggest that at temperatures of 180° F. the maltodextrin coating degrades and leads to the release of the nanosilica particle (C) from the maltodextrin coating (B) as shown in the schematic of FIG. 5, where (A) represents the maltodextrin-coated nanosilica.

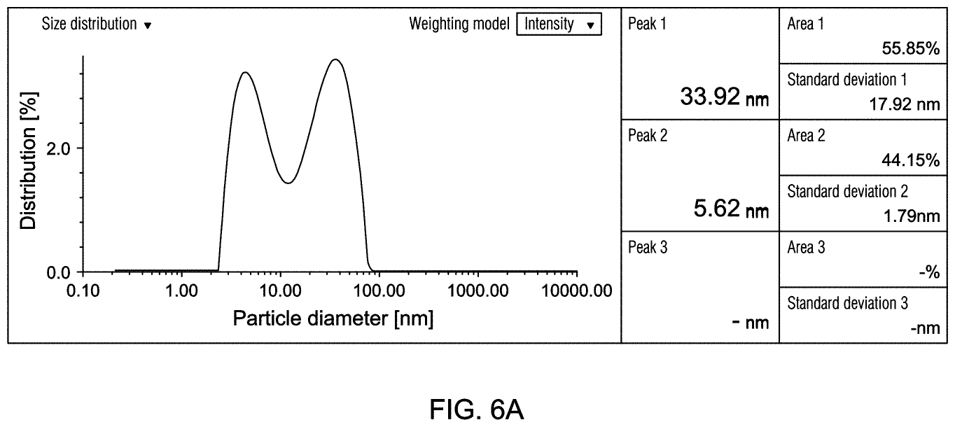

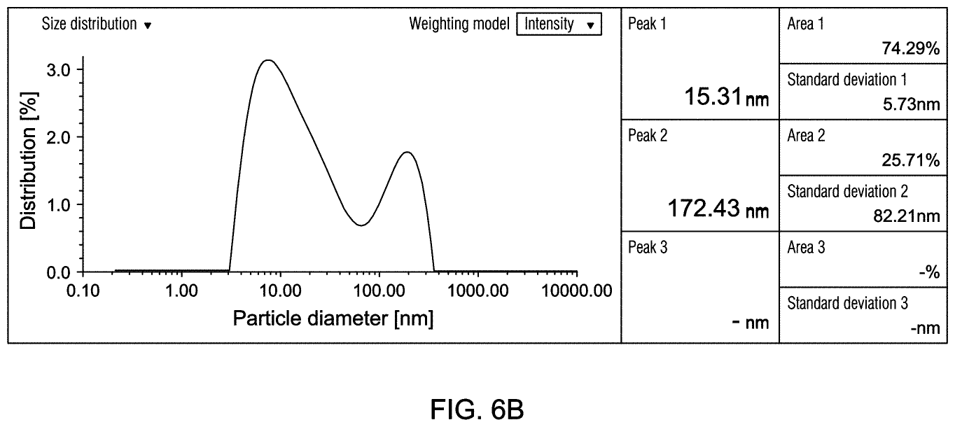

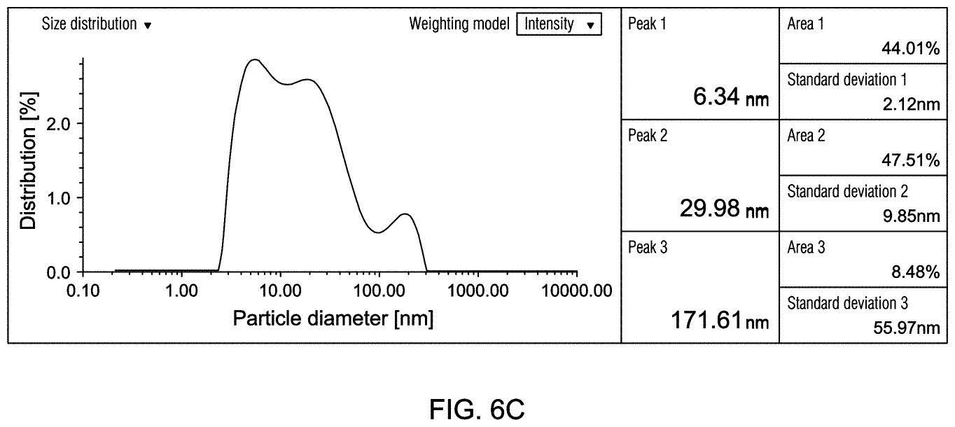

A comparison of the static gel strength development between the Baseline Formulation, the Sample 1 Formulation and the Sample 2 Formulation is shown in FIG. 6. FIG. 6 shows a comparison of the gel strength development at 180° F. of the slurry formulations from 0 to 500 lbf/100 sq ft.

C. Slurry Formulation Designs for 250° F.

The slurry formulations for the 250° F. tests were developed according to the compositions shown in Table 10. The slurry formulations were adjusted to display thickening times to 100 Bearden units of consistency (Bc) of approximately 6 hours. For each test, a 30 minute ramp time to 250° F. was used. Three hours of conditioning at 250° F. was used to determine the transition time. A retarder system of zinc oxide and AMPS/acrylic acid copolymer was used.

TABLE 10
Slurry designs for 250° F.

| | Baseline | | Uncoated | | Sample 1 | | Sample 2 | |
|---|---|---|---|---|---|---|---|---|
| | Formulation | | Formulation | | Formulation | | Formulation | |
| | Amount (g) | % BWOC | Amount (g) | % BWOC | Amount (g) | % BWOC | Amount (g) | % BWOC |
| Saudi class G cement | 785 | 100 | 785 | 100 | 785 | 100 | 785 | 100 |
| Water | 347 | N/A | 347 | N/A | 347 | N/A | 347 | N/A |
| Hydroxyethylcellulose | 1.00 | 0.13 | 1.00 | 0.13 | 1.00 | 0.13 | 1.00 | 0.13 |
| AMPS Acrylic Acid | 6.50 | 0.835 | 6.83 | 0.879 | 7.51 | 0.968 | 7.51 | 0.968 |
| copolymer | | | | | | | | |
| Zinc Oxide | 5.50 | 0.707 | 5.70 | 0.734 | 6.27 | 0.808 | 6.27 | 0.808 |
| Nanosilica Additive | 0 | 0 | 3.93 | 0.05 gps | 3.93 | 0.05 gps | 3.93 | 0.05 gps |

For the tests at 250° F., the slurry formulations were adjusted to display thickening times to 100 Bc of approximately 4 hours. For each test, a 30 minute ramp time to 250° F. was used. Thickening times and transition times for each sample are shown in Table 11.

TABLE 11
Thickening times and transition times

| | Baseline | Uncoated | Sample 1 | Sample 2 |
|---|---|---|---|---|
| | Formulation | Formulation | Formulation | Formulation |
| Thickening time | 3 hours and | 4 hours and | 3 hours and | 3 hours and |
| to 70 Bc | 57 minutes | 11 minutes | 47 minutes | 56 minutes |
| Thickening time | 4 hours and | 4 hours and | 3 hours and | 4 hours and |
| to 100 Bc | 3 minute | 15 minutes | 51 minutes | 1 minute |
| Transition times | 10 minutes | —* | 9 minutes | 10 minutes |

*Transition time not available

The results in Table 11 show rapid transition times for each sample. This could be a result of the chemistry of the retarder system. Alternately, the difference in transition time could be due to instrument error.

The Sample 2 Formulation shows a substantially higher compressive strength at 12 and 24 hours as compared with the other slurry formulations. The Sample 2 Formulation showed compressive strengths of 1470 and 3737 psi for 12 and 24 hours. This was the highest early strength of the four slurries. The Sample 2 slurry also showed the highest 96 hour compressive strength at 4820 psi as compared with 4174 psi for the Baseline Formulation, 4204 psi for the Uncoated Formulation, and 3791 psi for the Sample 1 Formulation. The results show that the nanosilica-containing cement formulations, the slurry formulations containing the gas migration additives, have substantially shorter transition times compared to the slurry formulations with no nanosilica or uncoated nanosilicas. Thus, the results suggest that at temperatures of 180° F. the maltodextrin coating degrades and leads to the release of the nanosilica particle (C) from the maltodextrin coating (B) as shown in the schematic of FIG. 5, where (A) represents the maltodextrin-coated nanosilica.

D. Slurry Formulation Designs for 228° F.

The slurry formulations for the 228° F. tests were developed according to the compositions shown in Table 12. The slurry formulations were adjusted to display thickening times to 100 Bc of approximately 4 hours. For each test, a 30 minute ramp time to 228° F. was used. Two hours of conditioning at 228° F. was used to determine the transition time. The retarder system was HR-12 and HR-25.

TABLE 12
Slurry designs for 228° F.

| | Baseline | | Sample 2 | |
|---|---|---|---|---|
| | Formulation | | Formulation | |
| | Amount (g) | % BWOC | Amount (g) | % BWOC |
| Saudi class G | 635.54 | 100 | 635.3 | 100 |
| cement | | | | |
| Water | 193.37 | N/A | 191.81 | N/A |
| Silica flour | 222.44 | 35 | 222.35 | 35 |
| Microbond-HT | 31.78 | 5 | 31.76 | 5 |
| CFR-3 | 1.91 | 0.3 | 1.91 | 0.3 |
| Halad-344 | 0.64 | 0.1 | 0.64 | 0.1 |
| HR-12 | 6.48 | 1.02 | 5.83 | 0.092 |
| HR-25 | 0.54 | 0.085 | 0.49 | 0.077 |
| Latex | 89.66 | 1.5 gps | 89.62 | 1.5 gps |
| Stabilizer-434 | 17.93 | 0.3 gps | 17.92 | 0.3 gps |
| Dair-3000 | 0.62 | 0.012 gps | 0.62 | 0.012 gps |
| Nanosilica | 0 | 0 | 3.18 | 0.05 gps |
| Additive | | | | |

For the tests at 228° F., the slurry formulations were adjusted to display thickening times to 100 Bc of approximately 5 hours. For each test, a 30 minute ramp time to 250° F. was used. Thickening times and transition times for each sample are shown in Table 11.

TABLE 13
Thickening times and transition times

| | Baseline | Sample 2 |
|---|---|---|
| | Formulation | Formulation |
| Thickening time to 70 Bc | 4 hours and | 4 hours and |
| | 41 minutes | 13 minutes |
| Thickening time to 100 Bc | 4 hours and | 4 hours and |
| | 53 minutes | 21 minutes |
| Transition times | 5 hours and | 4 hours and |
| | 46 minutes | 58 minutes |

The results in Table 13 suggest degradation of the maltodextrin coating similar to the results seen in Table 9.

Comparing the results observed in Tables 9 and 11 to the results recorded in Table 13, shows the impact that different retarder systems can have on the transition time. The introduction of the maltodextrin-coated nanosilica in the Sample 2 Formulation in Table 12 reduces the transition time compared to the formulation without nanosilica particles. However, the impact is minimal compared to the results of the formulations shown in Tables 9 and 11. This suggests that the retarder system can impact the effectiveness of the gas migration additive.

The maltodextrin-coated nanosilica reduces the transition times observed from 180° F. to 228° F. in cement slurries. The impact is minimal at temperatures of 250° F., where all slurry formulations showed transition times of 10 minutes or less.

Although the embodiments have been described in detail, it should be understood that various changes, substitutions, and alterations can be made hereupon without departing from the principle and scope. Accordingly, the scope of the embodiments should be determined by the following claims and their appropriate legal equivalents.

There various elements described can be used in combination with all other elements described here unless otherwise indicated.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed here as from about one particular value to about another particular value and are inclusive unless otherwise indicated. When such a range is expressed, it is to be understood that another embodiment is from the one particular value to the other particular value, along with all combinations within said range.

As used here and in the appended claims, the words “comprise,” “has,” and “include” and all grammatical variations thereof are each intended to have an open, non-limiting meaning that does not exclude additional elements or steps.

1. A method of using a nanosilica-containing cement in a well cementing operation in a well, the method comprising the steps of:
pumping a nanosilica-containing cement formulation into the well, wherein the nanosilica-containing cement formulation comprises maltodextrin-coated nanosilica and a cement formulation, where the maltodextrin-coated nanosilica comprises nanosilica particles encapsulated by maltodextrin coating, wherein the pH of the nanosilica-containing cement formulation is between 9 and 14;
maintaining a temperature in the well due to a temperature of a formation surrounding the well, wherein the disintegration of the maltodextrin coating is initiated due to the temperature and pH of the nanosilica-containing cement;
exposing the nanosilica particles due to the disintegration of the maltodextrin coating from the maltodextrin-coated nanosilica; and
reacting the nanosilica particles with the cement formulation to form a set cement, wherein the transition time of the nanosilica-containing cement formulation is reduced compared to the transition time of the cement formulation.

2. The method of claim 1, further comprising the steps of:
mixing an amount of maltodextrin with a nanosilica particle solution to produce a maltodextrin-containing solution, where the nanosilica particle solution comprises the nanosilica particles suspended in water, where mixing continues until all of the maltodextrin is dissolved;
mixing an amount of borate with the maltodextrin-containing solution to produce a pre-reaction mixture, wherein the borate is selected from the group consisting of sodium tetraborate, potassium tetraborate, boric acid, and combination of the same;
sonicating the pre-reaction mixture in an ultrasonic bath to produce a sonicated mixture at a temperature between 90° F. (32.2° C.) and 100° F. (37.8° C.);
mixing the sonicated mixture at ambient conditions for at least 12 hours to produce the reaction mixture; and
separating the reaction mixture to produce the maltodextrin-coated nanosilica, wherein the maltodextrin is covalently bound to a surface of the nanosilica particles through a boronic ester functional group.

3. The method of claim 1, further comprising the step of mixing the maltodextrin-coated nanosilica and the cement formulation to produce the nanosilica-containing cement formulation.

4. The method of claim 1, wherein the nanosilica particles in the nanosilica-containing cement formulation are present in an amount between 0.01% by weight of cement and 10% by weight of cement.

5. A composition to provide on-demand release of a silica nanoparticle into a cement formulation, the composition comprising:
a maltodextrin-coated nanosilica particle comprising:
a nanosilica particle, and
a maltodextrin coating, where the maltodextrin coating comprises a boronic ester bound maltodextrin surrounding the nanosilica particle; and
the cement formulation comprising water and a cement.

6. The composition of claim 5, where the nanosilica is present in an amount between 0.01% by weight of cement and 10% by weight of cement.

7. A method of producing a nanosilica-containing cement formulation, the method comprising the steps of:
mixing an amount of maltodextrin with a nanosilica particle solution to produce a maltodextrin-containing solution, where the nanosilica particle solution comprises nanosilica particles suspended in water, where mixing continues until all of the maltodextrin is dissolved;
mixing an amount of borate with the maltodextrin-containing solution to produce a pre-reaction mixture, wherein the borate is selected from the group consisting of sodium tetraborate, potassium tetraborate, boric acid, and combination of the same;
sonicating the pre-reaction mixture in an ultrasonic bath to produce a sonicated mixture at a temperature between 90° F. (32.2° C.) and 100° F. (37.8° C.);
mixing the sonicated mixture at ambient conditions for at least 12 hours to produce the reaction mixture;
separating the reaction mixture to produce a maltodextrin-coated nanosilica; and
mixing the maltodextrin-coated nanosilica with cement formulations to produce the nanosilica-containing cement formulations, wherein the cement formulations comprise water and a cement.
